(19) United States
(12) Patent Application Publication
(10) Pub. No.: US 2025/0077802 A1
(43) Pub. Date: Mar. 6, 2025

(54) SYSTEMS AND METHODS FOR REAL-TIME SYNCHRONIZATION OF LIVE AUDIO TRANSLATION

(71) Applicant: Mixhalo Corp., San Francisco, CA (US)

(72) Inventors: Vikram Singh, San Francisco, CA (US); Alan Salvador Teran, Coconut Creek, FL (US); Taylor Galbraith, San Francisco, CA (US); Charles Edward Luckhardt, IV, San Francisco, CA (US); Jeffrey Thomas Miller, San Diego, CA (US); John Denton Vars, San Francisco, CA (US)

(21) Appl. No.: 18/820,546

(22) Filed: Aug. 30, 2024

Related U.S. Application Data
(60) Provisional application No. 63/536,208, filed on Sep. 1, 2023.

(51) Int. Cl. G06F 40/58; G10L 15/00

(52) U.S. Cl. CPC G06F 40/58; G10L 15/005

(57) ABSTRACT

A method for synchronization of translation audio data includes receiving a live audio signal corresponding to a live event having spoken words in an original language. The method also includes translating the live audio signal to a first translated language and a second translated language and producing a first translated audio signal based on the first translated language and a second translated audio signal based on the second translated language. A first segment of the first translated audio signal having a first duration and a first segment of the second translated audio signal having a second duration that is longer than the first duration. The method also includes processing the first segment of the first translated audio signal into a processed first segment having a duration equal to the second duration and transmitting the processed first segment to a first mobile computing device at the live event.

### RELATED APPLICATION(S)

This application claims priority to U.S. Provisional Patent Application No. 63/536,208, filed Sep. 1, 2023, the entire disclosure of which is incorporated herein by reference.

### FIELD OF THE INVENTION

This invention relates generally to the field of real-time delivery of data over wireless networks. More specifically, the invention relates to systems and methods for delivery and synchronization of translation audio data to mobile computing devices over wireless networks.

### BACKGROUND

Live event translation services have traditionally depended on human interpreters and translation devices rented out by the live event venue. Recent developments in AI-based translation services allow for near real-time speech translation on a user's mobile computing device without the need for human interpreters. However, languages are often translated at different speeds—for example, some requiring longer sentences than others. Therefore, there is a need for systems and methods that synchronize the translations among various users that are in relatively close proximity.

### SUMMARY

The present invention includes systems and methods for synchronization of translation data at a live event using stretching or delaying techniques. For example, the present invention includes systems and methods for receiving a live audio signal corresponding to a live event and translating the live audio signal from an original language to one or more translated languages. The present invention also includes systems and methods for producing translated audio signals based on the one or more translated languages—the translated audio signals having segments of varying durations. The present invention also includes systems and methods for processing one or more segments of the translated audio signals by stretching or adding silent audio to the segments and transmitting the processed segments of the translated audio signals to one or more mobile computing devices at the live event via a wireless network.

The present invention also includes systems and methods for synchronization of translation data at a live event using compression or playback speed adjustment techniques. For example, the present invention includes systems and methods for receiving a live audio signal corresponding to a live event and translating the live audio signal from an original language to one or more translated languages. The present invention also includes systems and methods for producing translated audio signals based on the one or more translated languages—the translated audio signals having segments of varying durations. The present invention also includes systems and methods for processing one or more segments of the translated audio signals by compressing or adjusting the playback speed of the segments and transmitting the processed segments of the translated audio signals to one or more mobile computing devices at the live event via a wireless network.

In one aspect, the invention includes a computerized method for synchronization of translation audio data at a live event. The computerized method includes receiving, by an audio server computing device, a live audio signal corresponding to the live event. The live audio signal including spoken words in an original language. The computerized method also includes translating, by the audio server computing device, the live audio signal corresponding to the live event from the original language to a first translated language and a second translated language. The computerized method also includes producing, by the audio server computing device, a first translated audio signal based on the first translated language and a second translated audio signal based on the second translated language.

A first segment of the first translated audio signal is of a first duration and a first segment of the second translated audio signal is of a second duration—the second duration being longer than the first duration. The computerized method also includes processing, by the audio server computing device, the first segment of the first translated audio signal into a processed first segment of the first translated audio signal having a duration equal to the second duration. The computerized method also includes transmitting, by the audio server computing device, the processed first segment of the first translated audio signal to a first mobile computing device at the live event via a wireless network and the first segment of the second translated audio signal to a second mobile computing device at the live event via the wireless network.

In some embodiments, the first segment of the first translated audio signal and the first segment of the second translated audio signal each include at least one sentence. For example, in some embodiments, processing the first segment of the first translated audio signal into the processed first segment of the first translated audio signal includes adding silent audio before a start of a sentence of the first segment. In other embodiments, processing the first segment of the first translated audio signal into the processed first segment of the first translated audio signal includes adding silent audio after an end of a sentence of the first segment. In some embodiments, processing the first segment of the first translated audio signal into the processed first segment of the first translated audio signal includes adjusting a pitch of the first segment of the first translated audio signal.

In another aspect, the invention includes a system for synchronization of translation audio data at a live event. The system includes an audio server computing device communicatively coupled to a first mobile computing device and a second mobile computing device over a wireless network. The audio server computing device is configured to receive a live audio signal corresponding to the live event. The live audio signal including spoken words in an original language. The audio server computing device is also configured to translate the live audio signal corresponding to the live event from the original language to a first translated language and a second translated language. The audio server computing device is also configured to produce a first translated audio signal based on the first translated language and a second translated audio signal based on the second translated language.

A first segment of the first translated audio signal is of a first duration and a first segment of the second translated audio signal is of a second duration-the second duration being longer than the first duration. The audio server computing device is also configured to process the first segment of the first translated audio signal into a processed first segment of the first translated audio signal having a duration equal to the second duration. The audio server computing device is also configured to transmit the processed first segment of the first translated audio signal to the first mobile computing device at the live event via the wireless network and the first segment of the second translated audio signal to the second mobile computing device at the live event via the wireless network.

In some embodiments, the first segment of the first translated audio signal and the first segment of the second translated audio signal each include at least one sentence. For example, in some embodiments, processing the first segment of the first translated audio signal into the processed first segment of the first translated audio signal includes adding silent audio before a start of a sentence of the first segment. In other embodiments, processing the first segment of the first translated audio signal into the processed first segment of the first translated audio signal includes adding silent audio after an end of a sentence of the first segment. In some embodiments, processing the first segment of the first translated audio signal into the processed first segment of the first translated audio signal includes adjusting a pitch of the first segment of the first translated audio signal.

In another aspect, the invention includes a computerized method for synchronization of translation audio data at a live event. The computerized method includes receiving, by an audio server computing device, a live audio signal corresponding to the live event. The live audio signal including spoken words in an original language. The computerized method also includes translating, by the audio server computing device, the live audio signal corresponding to the live event from the original language to a first translated language and a second translated language. The computerized method also includes producing, by the audio server computing device, a first translated audio signal based on the first translated language and a second translated audio signal based on the second translated language.

A first segment of the first translated audio signal is of a first duration and a first segment of the second translated audio signal is of a second duration—the second duration being longer than the first duration. The computerized method also includes processing, by the audio server computing device, the first segment of the second translated audio signal into a processed first segment of the second translated audio signal having a duration equal to the first duration. The computerized method also includes transmitting, by the audio server computing device, the first segment of the first translated audio signal to a first mobile computing device at the live event via a wireless network and the processed first segment of the second translated audio signal to a second mobile computing device at the live event via the wireless network.

In some embodiments, the first segment of the first translated audio signal and the first segment of the second translated audio signal each include at least one sentence. In some embodiments, processing the first segment of the second translated audio signal into the processed first segment of the second translated audio signal includes compressing the first segment of the second translated audio signal. For example, in some embodiments, compressing the first segment of the second translated audio signal includes adjusting a playback speed of the first segment of the second translated audio signal. In some embodiments, processing the first segment of the second translated audio signal into the processed first segment of the second translated audio signal includes adjusting a pitch of the first segment of the second translated audio signal.

In another aspect, the invention includes a system for synchronization of translation audio data at a live event. The system includes an audio server computing device communicatively coupled to a first mobile computing device and a second mobile computing device over a wireless network. The audio server computing device is configured to receive a live audio signal corresponding to the live event. The live audio signal including spoken words in an original language. The audio server computing device is also configured to translate the live audio signal corresponding to the live event from the original language to a first translated language and a second translated language. The audio server computing device is also configured to produce a first translated audio signal based on the first translated language and a second translated audio signal based on the second translated language.

A first segment of the first translated audio signal is of a first duration and a first segment of the second translated audio signal is of a second duration—the second duration being longer than the first duration. The audio server computing device is also configured to process the first segment of the second translated audio signal into a processed first segment of the second translated audio signal having a duration equal to the first duration. The audio server computing device is also configured to transmit the first segment of the first translated audio signal to the first mobile computing device at the live event via the wireless network and the processed first segment of the second translated audio signal to the second mobile computing device at the live event via the wireless network.

In some embodiments, the first segment of the first translated audio signal and the first segment of the second translated audio signal each include at least one sentence. In some embodiments, processing the first segment of the second translated audio signal into the processed first segment of the second translated audio signal includes compressing the first segment of the second translated audio signal. For example, in some embodiments, compressing the first segment of the second translated audio signal includes adjusting a playback speed of the first segment of the second translated audio signal. In some embodiments, processing the first segment of the second translated audio signal into the processed first segment of the second translated audio signal includes adjusting a pitch of the first segment of the second translated audio signal.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic flow diagram illustrating a computerized process for synchronization of translation audio data at a live event using the system architecture of FIG. 1, according to an illustrative embodiment of the invention.

FIG. 3 is a schematic flow diagram illustrating a computerized process for synchronization of translation audio data at a live event using the system architecture of FIG. 1, according to an illustrative embodiment of the invention.

### DETAILED DESCRIPTION

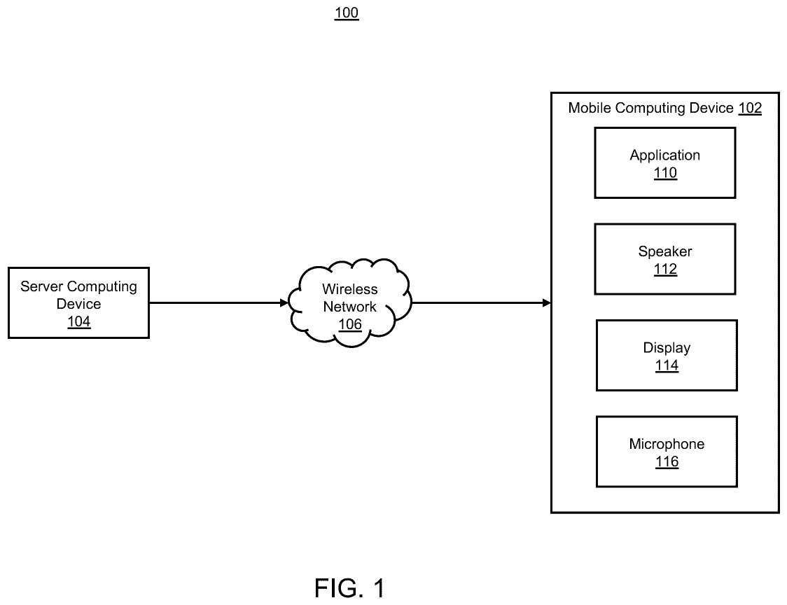

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110, one or more speakers 112, one or more displays 114, and one of more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth™). Mobile computing device 102 can then initiate playback of the live audio stream via the headphone.

Additional detail regarding illustrative technical features of the methods and systems described herein are found in U.S. Pat. No. 11,461,070, titled “Systems and Methods for Providing Real-Time Audio and Data” and issued Oct. 24, 2022, and U.S. Pat. No. 11,625,213, titled “Systems and Methods for Providing Real-Time Audio and Data,” and issued Apr. 11, 2023, the entirety of each of which is incorporated herein by reference.

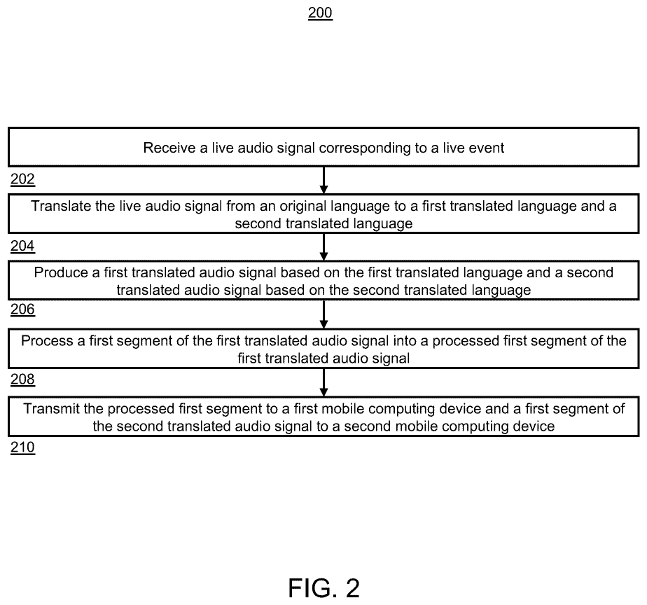

FIG. 2 is a schematic flow diagram illustrating a computerized process 200 for synchronization of translation audio data at a live event using system 100, according to an illustrative embodiment of the invention. Process 200 begins by receiving, by an audio server computing device 104, a live audio signal corresponding to the live event at step 202. The live audio signal comprises speech (i.e., spoken words) in an original language. Process 200 continues by translating, by the audio server computing device 104, the live audio signal corresponding to the live event from the original language to a first translated language and a second translated language at step 204. In some embodiments, the audio server computing device 104 executes a deep learning encoder-decoder Transformer model to perform the translation of the live audio signal from the original language to the first translated language and the second translated language. An exemplary Transformer model that can be executed by audio server computing device is the Whisper™ speech recognition model from OpenAI, as described in A. Radford et al., “Robust Speech Recognition via Large-Scale Weak Supervision,” arXiv:2212.04356v1 [eess.AS], Dec. 6, 2022, available at arxiv.org/pdf/2212.04356, which is incorporated herein by reference. For example, the audio server computing device 104 samples at least a portion of the live audio signal, converts the sampled audio signal into a spectrographic representation (e.g., a Log-Mel spectrogram), and provides the spectrographic representation to the Transformer model. The Transformer model analyzes the input to identify and translate the spoken words into another language, then generate a text transcription of the translated language.

Process 200 continues by producing, by the audio server computing device 104, a first translated audio signal based on the first translated language and a second translated audio signal based on the second translated language at step 206. In some embodiments, the audio server computing device 104 produces the first translated audio signal and the second translated audio signal using a neural network architecture comprised of a sequence-to-sequence model that receives the translated text as input and generates Mel spectrograms from the input text, and a vocoder model that converts the Mel spectrograms into waveform samples that comprise spoken words corresponding to the translated text. An exemplary neural network architecture that can be used by the audio server computing device 104 to perform the generation of the first translated audio signal and the second translated audio signal is described in J. Shen et al., “Natural TTS Synthesis by Conditioning WaveNet on Mel Spectrogram Predictions,” arXiv:1712.05884v2 [cs.CL], Feb. 16, 2018, available at arxiv.org/pdf/1712.05884, which is incorporated herein by reference.

Due to the inherent differences in spoken language, in some embodiments a first segment of the first translated audio signal may be of a first duration and a first segment of the second translated audio signal may be of a second duration—the second duration being longer than the first duration. In some embodiments, the first segment of the first translated audio signal and the first segment of the second translated audio signal each include at least one sentence. As an example, the English phrase “Today we will discuss the new projects our company is working on”—when translated to a first language such as Spanish—may result in an audio sample that has a duration of four seconds. However, when that same phrase is translated to a second language such as Chinese, it may result in an audio sample that has a duration of six seconds. As can be appreciated, even small differences in audio duration can have a compound effect on the overall speed of speech translation into the respective languages. Over the course of an entire translation session, the translation of speech into a given language may end up taking significantly longer than translation of the speech into another language—which results in perceptible asynchronization between the respective translations.

To overcome this issue, process 200 continues by processing, by the audio server computing device 104, the first segment of the first translated audio signal into a processed first segment of the first translated audio signal having a duration equal to the second duration at step 208. In some embodiments, processing the first segment of the first translated audio signal into the processed first segment of the first translated audio signal includes adding silent audio before a start of a sentence of the first segment. In other embodiments, processing the first segment of the first translated audio signal into the processed first segment of the first translated audio signal includes adding silent audio after an end of a sentence of the first segment. In some embodiments, processing the first segment of the first translated audio signal into the processed first segment of the first translated audio signal includes adjusting a pitch of the first segment of the first translated audio signal. By matching the duration of the respective translated audio segments, the audio server computing device 104 ensures that the speech translations delivered to audience members remain synchronized in time, no matter which language is being translated.

In some embodiments, the audio server computing device 104 uses digital audio processing hardware and/or software to modify the first segment of the first translated audio signal so that the duration matches the duration of the first segment of the second translated audio signal. For example, the audio server computing device 104 can determine a start timestamp and an end timestamp of the first segment of the second translated audio signal—in one example, the start and end timestamps may relate to the first segment only (e.g., the segment starts at 00:00:00 and ends at 00:00:15) and in another example, the start and end timestamps may relate to the overall audio signal (e.g., the segment starts at 00:10:45 of the overall audio signal and ends at 00:11:00 of the overall audio signal).

Using the above example, the first segment of the second translated audio signal has a duration of 15 seconds. In the case where the first segment of the first translated audio signal has a duration of 12 seconds, the audio server computing device 104 can adjust the duration of the first segment of the first translated audio signal by any of the following: (i) adding 3 seconds of silent audio to the beginning or the end of the first segment of the first translated audio signal, (ii) changing a compression of the first segment of the first translated audio signal so that the duration of the segment is 15 seconds, or (iii) changing a pitch of the first segment of the first translated audio signal so that the duration of the segment is 15 seconds.

Process 200 finishes by transmitting, by the audio server computing device 104, the processed first segment of the first translated audio signal to a first mobile computing device 102 at the live event via a wireless network 106 and the first segment of the second translated audio signal to a second mobile computing device 102 at the live event via the wireless network 106 at step 210.

Process 200 can be implemented using a system for synchronization of translation audio data at a live event. The system includes an audio server computing device 104 communicatively coupled to a first mobile computing device 102 and a second mobile computing device 102 over a wireless network 106. The audio server computing device 104 is configured to receive a live audio signal corresponding to the live event. The live audio signal including spoken words in an original language. The audio server computing device 104 is also configured to translate the live audio signal corresponding to the live event from the original language to a first translated language and a second translated language.

The audio server computing device 104 is also configured to produce a first translated audio signal based on the first translated language and a second translated audio signal based on the second translated language. A first segment of the first translated audio signal is of a first duration and a first segment of the second translated audio signal is of a second duration—the second duration being longer than the first duration. In some embodiments, the first segment of the first translated audio signal and the first segment of the second translated audio signal each include at least one sentence.

The audio server computing device 104 is also configured to process the first segment of the first translated audio signal into a processed first segment of the first translated audio signal having a duration equal to the second duration. In some embodiments, processing the first segment of the first translated audio signal into the processed first segment of the first translated audio signal includes adding silent audio before a start of a sentence of the first segment. In other embodiments, processing the first segment of the first translated audio signal into the processed first segment of the first translated audio signal includes adding silent audio after an end of a sentence of the first segment. In some embodiments, processing the first segment of the first translated audio signal into the processed first segment of the first translated audio signal includes adjusting a pitch of the first segment of the first translated audio signal.

The audio server computing device 104 is also configured to transmit the processed first segment of the first translated audio signal to the first mobile computing device 102 at the live event via the wireless network 106 and the first segment of the second translated audio signal to the second mobile computing device 102 at the live event via the wireless network 106.

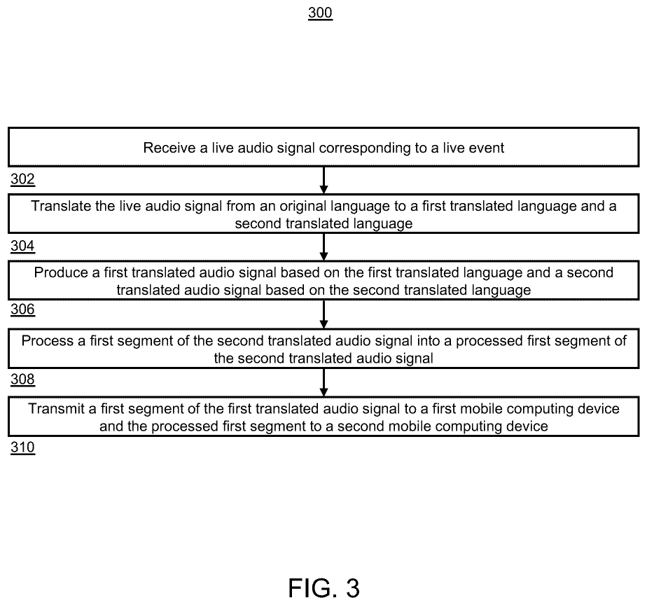

FIG. 3 is a schematic flow diagram illustrating a computerized process 300 for synchronization of translation audio data at a live event using system 100, according to an illustrative embodiment of the invention. Process 300 begins by receiving, by an audio server computing device 104, a live audio signal corresponding to the live event at step 302. The live audio signal including spoken words in an original language. Process 300 continues by translating, by the audio server computing device 104, the live audio signal corresponding to the live event from the original language to a first translated language and a second translated language at step 304.

Process 300 continues by producing, by the audio server computing device 104, a first translated audio signal based on the first translated language and a second translated audio signal based on the second translated language at step 306. A first segment of the first translated audio signal is of a first duration and a first segment of the second translated audio signal is of a second duration—the second duration being longer than the first duration. In some embodiments, the first segment of the first translated audio signal and the first segment of the second translated audio signal each include at least one sentence.

Process 300 continues by processing, by the audio server computing device 104, the first segment of the second translated audio signal into a processed first segment of the second translated audio signal having a duration equal to the first duration at step 308. In some embodiments, processing the first segment of the second translated audio signal into the processed first segment of the second translated audio signal includes compressing the first segment of the second translated audio signal. For example, in some embodiments, compressing the first segment of the second translated audio signal includes adjusting a playback speed of the first segment of the second translated audio signal. In some embodiments, processing the first segment of the second translated audio signal into the processed first segment of the second translated audio signal includes adjusting a pitch of the first segment of the second translated audio signal.

Process 300 finishes by transmitting, by the audio server computing device 104, the first segment of the first translated audio signal to a first mobile computing device 102 at the live event via a wireless network 106 and the processed first segment of the second translated audio signal to a second mobile computing device 102 at the live event via the wireless network 106 at step 310.

Process 300 can be implemented using a system for synchronization of translation audio data at a live event. The system includes an audio server computing device 104 communicatively coupled to a first mobile computing device 102 and a second mobile computing device 102 over a wireless network 106. The audio server computing device 104 is configured to receive a live audio signal corresponding to the live event. The live audio signal including spoken words in an original language. The audio server computing device 104 is also configured to translate the live audio signal corresponding to the live event from the original language to a first translated language and a second translated language.

The audio server computing device 104 is also configured to produce a first translated audio signal based on the first translated language and a second translated audio signal based on the second translated language. A first segment of the first translated audio signal is of a first duration and a first segment of the second translated audio signal is of a second duration—the second duration being longer than the first duration. In some embodiments, the first segment of the first translated audio signal and the first segment of the second translated audio signal each include at least one sentence.

The audio server computing device 104 is also configured to process the first segment of the second translated audio signal into a processed first segment of the second translated audio signal having a duration equal to the first duration. In some embodiments, processing the first segment of the second translated audio signal into the processed first segment of the second translated audio signal includes compressing the first segment of the second translated audio signal. For example, in some embodiments, compressing the first segment of the second translated audio signal includes adjusting a playback speed of the first segment of the second translated audio signal. In some embodiments, processing the first segment of the second translated audio signal into the processed first segment of the second translated audio signal includes adjusting a pitch of the first segment of the second translated audio signal.

The audio server computing device 104 is also configured to transmit the first segment of the first translated audio signal to the first mobile computing device 102 at the live event via the wireless network 106 and the processed first segment of the second translated audio signal to the second mobile computing device 102 at the live event via the wireless network 106.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e. g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for synchronization of translation audio data at a live event, the method comprising:
receiving, by an audio server computing device, a live audio signal corresponding to the live event, wherein the live audio signal comprises a plurality of spoken words in an original language;
translating, by the audio server computing device, the live audio signal corresponding to the live event from the original language to a first translated language and a second translated language;
producing, by the audio server computing device, a first translated audio signal based on the first translated language and a second translated audio signal based on the second translated language,
wherein a first segment of the first translated audio signal comprises a first duration and a first segment of the second translated audio signal comprises a second duration, wherein the second duration is longer than the first duration;
processing, by the audio server computing device, the first segment of the first translated audio signal into a processed first segment of the first translated audio signal comprising a duration equal to the second duration; and
transmitting, by the audio server computing device, the processed first segment of the first translated audio signal to a first mobile computing device at the live event via a wireless network and the first segment of the second translated audio signal to a second mobile computing device at the live event via the wireless network.

2. The computerized method of claim 1, wherein the first segment of the first translated audio signal and the first segment of the second translated audio signal each comprise at least one sentence.

3. The computerized method of claim 2, wherein processing the first segment of the first translated audio signal into the processed first segment of the first translated audio signal comprises adding silent audio before a start of a sentence of the first segment.

4. The computerized method of claim 2, wherein processing the first segment of the first translated audio signal into the processed first segment of the first translated audio signal comprises adding silent audio after an end of a sentence of the first segment.

5. The computerized method of claim 1, wherein processing the first segment of the first translated audio signal into the processed first segment of the first translated audio signal comprises adjusting a pitch of the first segment of the first translated audio signal.

6. A system for synchronization of translation audio data at a live event, the system comprising:
an audio server computing device communicatively coupled to a first mobile computing device and a second mobile computing device over a wireless network, the audio server computing device configured to:
receive a live audio signal corresponding to the live event, wherein the live audio signal comprises a plurality of spoken words in an original language;
translate the live audio signal corresponding to the live event from the original language to a first translated language and a second translated language;
produce a first translated audio signal based on the first translated language and a second translated audio signal based on the second translated language,
wherein a first segment of the first translated audio signal comprises a first duration and a first segment of the second translated audio signal comprises a second duration, wherein the second duration is longer than the first duration;
process the first segment of the first translated audio signal into a processed first segment of the first translated audio signal comprising a duration equal to the second duration; and
transmit the processed first segment of the first translated audio signal to the first mobile computing device at the live event via the wireless network and the first segment of the second translated audio signal to the second mobile computing device at the live event via the wireless network.

7. The system of claim 6, wherein the first segment of the first translated audio signal and the first segment of the second translated audio signal each comprise at least one sentence.

8. The system of claim 7, wherein processing the first segment of the first translated audio signal into the processed first segment of the first translated audio signal comprises adding silent audio before a start of a sentence of the first segment.

9. The system of claim 7, wherein processing the first segment of the first translated audio signal into the processed first segment of the first translated audio signal comprises adding silent audio after an end of a sentence of the first segment.

10. The system of claim 6, wherein processing the first segment of the first translated audio signal into the processed first segment of the first translated audio signal comprises adjusting a pitch of the first segment of the first translated audio signal.

11. A computerized method for synchronization of translation audio data at a live event, the method comprising:
receiving, by an audio server computing device, a live audio signal corresponding to the live event, wherein the live audio signal comprises a plurality of spoken words in an original language;
translating, by the audio server computing device, the live audio signal corresponding to the live event from the original language to a first translated language and a second translated language;
producing, by the audio server computing device, a first translated audio signal based on the first translated language and a second translated audio signal based on the second translated language,
wherein a first segment of the first translated audio signal comprises a first duration and a first segment of the second translated audio signal comprises a second duration, wherein the second duration is longer than the first duration;
processing, by the audio server computing device, the first segment of the second translated audio signal into a processed first segment of the second translated audio signal comprising a duration equal to the first duration; and
transmitting, by the audio server computing device, the first segment of the first translated audio signal to a first mobile computing device at the live event via a wireless network and the processed first segment of the second translated audio signal to a second mobile computing device at the live event via the wireless network.

12. The computerized method of claim 11, wherein the first segment of the first translated audio signal and the first segment of the second translated audio signal each comprise at least one sentence.

13. The computerized method of claim 11, wherein processing the first segment of the second translated audio signal into the processed first segment of the second translated audio signal comprises compressing the first segment of the second translated audio signal.

14. The computerized method of claim 13, wherein compressing the first segment of the second translated audio signal comprises adjusting a playback speed of the first segment of the second translated audio signal.

15. The computerized method of claim 11, wherein processing the first segment of the second translated audio signal into the processed first segment of the second translated audio signal comprises adjusting a pitch of the first segment of the second translated audio signal.

16. A system for synchronization of translation audio data at a live event, the system comprising:
an audio server computing device communicatively coupled to a first mobile computing device and a second mobile computing device over a wireless network, the audio server computing device configured to:
receive a live audio signal corresponding to the live event, wherein the live audio signal comprises a plurality of spoken words in an original language;
translate the live audio signal corresponding to the live event from the original language to a first translated language and a second translated language;
produce a first translated audio signal based on the first translated language and a second translated audio signal based on the second translated language,
wherein a first segment of the first translated audio signal comprises a first duration and a first segment of the second translated audio signal comprises a second duration, wherein the second duration is longer than the first duration;
process the first segment of the second translated audio signal into a processed first segment of the second translated audio signal comprising a duration equal to the first duration; and
transmit the first segment of the first translated audio signal to the first mobile computing device at the live event via the wireless network and the processed first segment of the second translated audio signal to the second mobile computing device at the live event via the wireless network.

17. The system of claim 16, wherein the first segment of the first translated audio signal and the first segment of the second translated audio signal each comprise at least one sentence.

18. The system of claim 16, wherein processing the first segment of the second translated audio signal into the processed first segment of the second translated audio signal comprises compressing the first segment of the second translated audio signal.

19. The system of claim 18, wherein compressing the first segment of the second translated audio signal comprises adjusting a playback speed of the first segment of the second translated audio signal.

20. The system of claim 16, wherein processing the first segment of the second translated audio signal into the processed first segment of the second translated audio signal comprises adjusting a pitch of the first segment of the second translated audio signal.
